(19) United States
(12) Patent Application Publication
(10) Pub. No.: US 2005/0259548 A1
(43) Pub. Date: Nov. 24, 2005

(54) Music playing method and apparatus thereof

(75) Inventor: Ping-Cheng Chang, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/131,383

(22) Filed: May 18, 2005

(30) Foreign Application Priority Data
May 20, 2004 (TW) 93114330

(51) Int. Cl. G11B 5/09

(52) U.S. Cl. 369/59.1; 369/47.24; 369/47.1; 369/47.15

(57) ABSTRACT

A music playing method and disc drive apparatus thereof, for reading a compact disc (CD). The disc drive apparatus includes an interface electrically connected to the host, a decoder, and a reading unit for identifying the CD with an audio format or an encoded audio format and reporting to the host through the interface. The host sends out a command to the disc drive apparatus for outputting an analog audio signal. If the CD is the audio format, the reading unit outputs a track of the CD as a first analog audio signal. If the CD is the encoded audio format, the reading unit outputs a first encoded audio file as a first analog audio signal by the decoder.

This application claims the benefit of Taiwan application Serial No. 93114330, filed May 20, 2004, the subject matter of which is incorporated herein by reference.

### BACKGROUND OF THE INVENTION

1. Field of the Invention

The invention relates in general to a music playing method and an apparatus thereof, and more particularly to a method and an apparatus of playing an encoded audio file.

2. Description of the Related Art

With advanced and fast development of media industries, disc drives have been popularly applied to various entertainments in public lives. Although an audio CD can be played in a disc drive conventionally, one audio CD can be played only for 70 minutes due to its limited storage capacity. As a result, it can not satisfy users who would like to play music for a long period of time.

So far, the contents of an audio CD can be compressed into encoded audio files, such as MP3 or WMA files, by appropriate computer compression technology, and these encoded audio files take less storage capacity comparing to the audio files so as to extend the time of playing one CD.

However, the CD with encoded audio files can not be played by a conventional CD-ROM. It is necessary to use a host, such like a personal computer (PC) to read. The decoder at the host, such as MP3 software, decodes the encoded audio files in the CD firstly. That is to say, the host has to be equipped with software capable of decoding the encoded audio files in the CD to allow the CD to be played, which causes great inconvenience.

### SUMMARY OF THE INVENTION

It is therefore an object of the invention to provide a music playing method and a disc drive apparatus thereof. The disc drive apparatus simulated as a virtual disc drive apparatus having several trays decodes the encoded audio files according to the command sent out by the host and outputs the analog audio signals.

The invention achieves the above-identified object by providing a music playing method, for reading a compact disc (CD) in a disc drive apparatus and outputting an analog audio signal accordingly. The compact disc is electrically connected to a host. At the beginning, the disc drive apparatus identifies the CD with an audio format, an encoded audio format, or a virtual multi-disc format. If the CD is the audio format, the CD includes at least a track and the host sends out a first command of the audio format to the disc drive apparatus for outputting the analog audio signal according to the track. If the CD is the encoded audio format, the CD includes at least a first encoded audio file and the host sends out a second command of the encoded audio format to the disc drive apparatus for decoding the first encoded audio file and outputting the analog audio signal. If the CD is the virtual multi-disc format, the CD includes at least a plurality of catalogs, each of which at least includes a second encoded audio file simulated as a virtual disc by the disc drive apparatus, and the host sends out a third command of the audio format to the disc drive apparatus for decoding the second encoded audio file and outputting the analog audio signal.

Also, the invention achieves the above-identified object by providing a disc drive apparatus, for reading a compact disc (CD). The disc drive apparatus includes an interface electrically connected to the host, a decoder, and a reading unit for identifying the CD with an audio format or an encoded audio format and reporting to the host through the interface. The host sends out a command to the disc drive apparatus for outputting an analog audio signal. If the CD is the audio format, the reading unit outputs a track of the CD as a first analog audio signal. If the CD is the encoded audio format, the reading unit outputs a second analog audio signal after a first encoded audio file of the CD is decoded by the decoder.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a computer system according to a preferred embodiment of the invention.

FIG. 2 is a flow chart showing a music playing method according to the preferred embodiment of the invention.

### DETAILED DESCRIPTION OF THE INVENTION

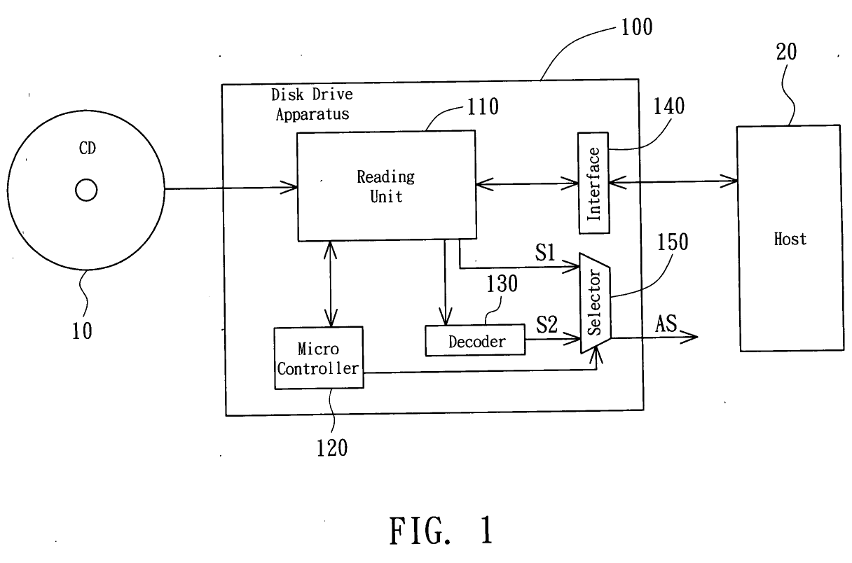

Referring to FIG. 1, which is a block diagram of a computer system according to the preferred embodiment of the invention. A computer system includes a host 20 and a disc drive apparatus 100, such as a CD-ROM, for reading a compact disc (CD) 10. The disc drive apparatus 100 is electrically connected to the host 20, and the host 20 sends out commands according to formats of the CD 10 to make the disc drive apparatus 100 output analog audio signals AS.

The disc drive apparatus 100 includes a reading unit 110, a micro controller 120, a decoder 130, an interface 140, and a selector 150. The micro controller 120 is for controlling the operation of the reading unit 110. The reading unit 11 is for identifying the CD 10 with an audio format or an encoded audio format and reporting to the host 20 through the interface 140. The CD with an audio format includes several tracks, which are most popular digital audio storage format used in record markets. In general, one song is stored in one track. On the other hand, the CD with an encoded audio format means that the CD contains at least one encoded audio file.

The interface 140 preferably is an IDE interface, and the decoder 130 is for decoding the encoded audio files and outputting the second analog audio signal S2. The selector 150 is electrically connected with the micro controller 120, for selecting a source of the analog audio signals AS.

If the CD 10 is the audio format, the reading unit 110 outputs the track of the CD 10 as the first analog audio signal S1. If the CD 10 is the encoded audio format, the reading unit 110 outputs the encoded audio file of the CD 10 as the second analog audio signal S2 by the decoder 130.

When the CD 10 is the audio format, the selector 150 selects and outputs the first analog audio signal S1 as the analog audio signal AS. When the CD 10 is the encoded audio format, the micro controller 120 enables the selector 150 to select and output the second analog audio signal S2 as the analog audio signal AS to be listened through speakers or earphones by users' ears.

Because the disc drive apparatus of the present invention has a built-in decoder to allow the encoded audio files of the CD being directly played by the disc drive apparatus instead of utilizing the host so as to bring more convenience to users and decrease loading of the host.

Moreover, the reading unit 110 further identifies the CD 10 with a virtual multi-disc format and reports to the host 20 through the interface 140. The CD with a virtual multi-disc format includes several encoded audio files, which are distributed in different catalogs. The factory owners who producing disc drive apparatuses can establish an identifying method themselves in order to identify the CD with a virtual multi-disc format or an encoded audio format. For example, one CD with a virtual multi-disc format can be simulated as a plurality of discs with an audio format according to the catalogs by the disc drive apparatus, so that the host can reckon the disc drive apparatus as a disc drive apparatus having multi-tray for containing CDs with an audio format.

If the CD is the virtual multi-disc format, a plurality of catalogs of the CD 10 are simulated as several virtual discs with audio formats by the reading unit 110 and the encoded audio files in each virtual disc are decoded by the decoder 130 in order to output a second analog audio signal S2. As a result, the host 20 reckons the disc drive apparatus 100 as a disc drive apparatus having several CDs with an audio format therein, and the host 20 can send out a command to play the CD with the virtual multi-disc format just like play a music CD.

Therefore, the disc drive apparatus 100 of the present invention provides advantages of a virtual disc drive apparatus having several multi-tray for playing more than one conventional audio CDs. Also, it is without any modification that the virtual disc drive apparatus can be applied to various hosts, such as a computer, a DVD player, and so on.

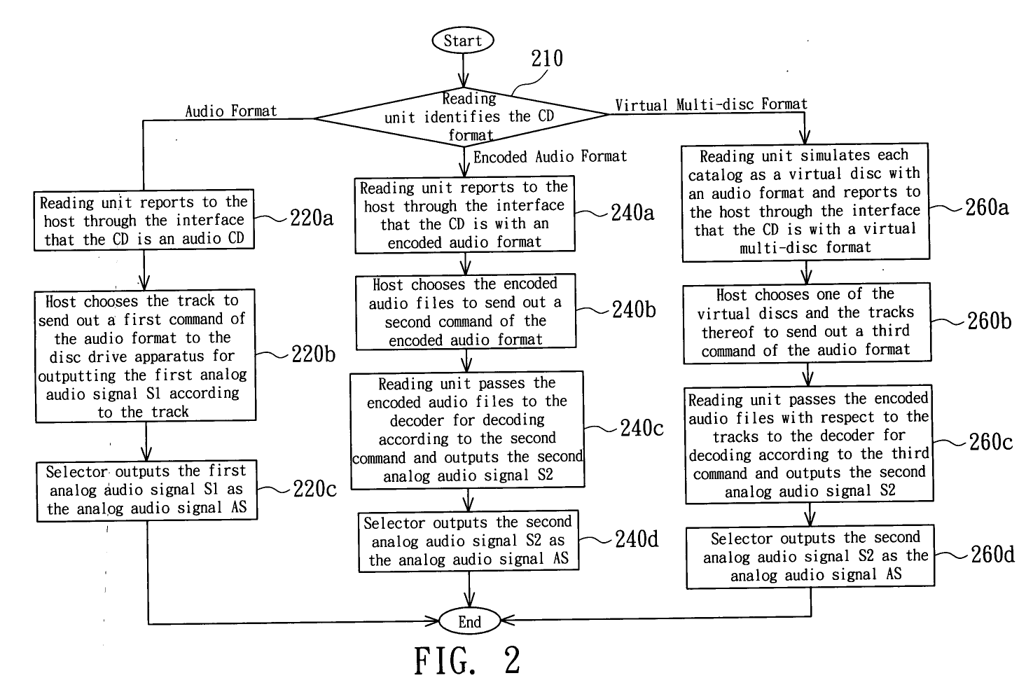

Please referring to both FIG. 1 and FIG. 2, FIG. 2 is a flow chart showing a music playing method according to the preferred embodiment of the invention. The music playing method of the present invention is using the disc drive apparatus 100 to read the CD 10 and output the analog audio signals AS accordingly. At first, in step 210, the reading unit 110 identifies the CD 10 as an audio format, an encoded audio format, or a virtual multi-disc format. The reading unit 110 preferably decides the CD 10 with a virtual multi-disc format in accordance with the label of the CD 10. The factory owners who producing disc drive apparatuses can establish an identifying method to identify the CD with a virtual multi-disc format when the label of the CD 10 is a predetermined word.

When the CD 10 is the audio format, steps 220a, 220b and 220c are performed in order to output an analog audio signal AS. The CD 10 includes at least one track, and, in step 220a, the reading unit 110 reports to the host 20 through the interface 140 that the CD is an audio CD. Next, in step 220b, the host 20 chooses the track to send out a first command of the audio format to the disc drive apparatus 100 for outputting the first analog audio signal S1 according to the track. Then, in step 220c, the selector 150 outputs the first analog audio signal S1 as the analog audio signal AS.

When the CD 10 is the encoded audio format, steps 240a, 240b, 240c and 240d are performed in order to output an analog audio signal AS. The CD 10 includes at least one encoded audio file, such as a MP3 file. In step 240a, the reading unit 110 reports to the host 20 through the interface 140 that the CD is with an encoded audio format. Next, in step 240b, the host 20 chooses the encoded audio files to send out a second command. Then, in step 240c, the reading unit 110 receives the second command from the host 20 and passes the encoded audio files to the decoder 130. The encoded audio files are decoded by the decoder 130 and the reading unit 110 outputs the second analog audio signal S2. In step 240d, the selector 150 outputs the second analog audio signal S2 as the analog audio signal AS.

When the CD 10 is the virtual multi-disc format, steps 260a, 260b, 260c and 260d are performed in order to output an analog audio signal AS. The CD 10 includes several catalogs, each of which includes at least one encoded audio file, such as a MP3 file. In step 260a, the reading unit 110 simulates each catalog as a virtual disc with an audio format and reports to the host 20 through the interface 140 that the CD is with a virtual multi-disc format. As a result, the disc drive apparatus 100 is reckoned as a disc drive apparatus having several CDs with an audio format therein for the host 20, and the disc drive apparatus 100 can be controlled by common music playing command and play the CD with the virtual multi-disc format just like play a music CD.

Next, in step 260b, the host 20 chooses one of the virtual discs and the tracks thereof to send out a third command of the audio format. Then, in step 260c, the reading unit 110 receives the third command from the host 20 through the interface 140 and passes the encoded audio files with respect to the tracks chosen to the decoder 130. The encoded audio files are decoded by the decoder 130 and the reading unit 110 outputs the second analog audio signal S2. In step 260d, the selector 150 outputs the second analog audio signal S2 as the analog audio signal AS.

The music playing method and the disc drive apparatus thereof disclosed in the above-mentioned preferred embodiment can directly play encoded audio files and simulate the disc drive apparatus as a virtual disc drive apparatus having several trays. Therefore, the present invention can improve the utilization of disc drive apparatus by play music longer and being applied to various hosts, such as computer, DVD player.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A music playing method, for reading a disc in a disc drive apparatus and outputting an analog audio signal accordingly, the disc drive being electrically connected to a host, the method comprising:
identifying the disc with an audio format, an encoded audio format, or a virtual multi-disc format by the disc drive apparatus;
wherein the disc includes at least a track, and the host sends out a first command of the audio format to the disc drive apparatus for outputting the analog audio signal according to the track, if the disc is the audio format;
wherein the disc includes at least a first encoded audio file, and the host sends out a second command of the encoded audio format to the disc drive apparatus for decoding the first encoded audio file and outputting the analog audio signal, if the disc is the encoded audio format; and
wherein the disc includes at least a plurality of catalogs, each of which includes at least a second encoded audio file being simulated as a virtual disc by the disc drive apparatus, and the host sends out a third command of the audio format to the disc drive apparatus for decoding the second encoded audio file and outputting the analog audio signal, if the disc is the virtual multi-disc format.

2. The music playing method according to claim 1, wherein the step of playing the first encoded audio file includes:
reporting to the host that the disc is with encoded audio format by the disc drive apparatus;
selecting the first encoded audio file and outputting the second command accordingly by the host; and
receiving the second command from the host to encode the first encoded audio file and play by the disc drive apparatus.

3. The music playing method according to claim 1, wherein the step of playing the second encoded audio file includes:
reporting to the host that the disc is with virtual multi-disc format by the disc drive apparatus;
selecting one of the virtual multi-discs and outputting the third command of the audio format accordingly by the host; and
receiving the third command from the host to encode the second encoded audio file and play by the disc drive apparatus.

4. The music playing method according to claim 3, wherein the third command includes at least the selected virtual multi-disc and a second track.

5. The music playing method according to claim 4, wherein the disc drive apparatus decides the second encoded audio file with respect to the second track in the step of receiving the third command.

6. The music playing method according to claim 1, wherein the step of identifying the disc is determined by if a label of the disc is a predetermined word.

7. The music playing method according to claim 1, wherein the first or the second encoded audio file has a format of MP3.

8. A disc drive apparatus, for reading an optical disc, comprising:
an interface, electrically connected to the host;
a decoder; and
a reading unit for identifying the optical disc with an audio format or an encoded audio format and reporting to the host through the interface;
wherein the host sends out a command to the disc drive apparatus for outputting an analog audio signal;
wherein the reading unit outputs a track of the optical disc as a first analog audio signal, if the optical disc is the audio format:
wherein the reading unit outputs a second analog audio signal after a first encoded audio file of the optical disc is decoded by the decoder, if the optical disc is the encoded audio format.

9. The disc drive apparatus according to claim 8, wherein the reading unit further identifies the optical disc with a virtual multi-disc format and reports to the host through the interface, while a plurality of catalogs are simulated as a plurality of virtual discs by the reading unit and a second encoded audio file is decoded by the decoder, so as to output a second analog audio signal, if the optical disc is the virtual multi-disc format.

10. The disc drive apparatus according to claim 9, wherein the disc drive apparatus further comprises a micro controller for controlling the operation of the reading unit.

11. The disc drive apparatus according to claim 10, further comprising a selector, electrically connected with the micro controller, for selecting a source of the analog audio signal, wherein the selector selects the first analog audio signal when the optical disc is the audio format, and the selector selects the second analog audio signal when the optical disc is the virtual multi-disc format.

12. The disc drive apparatus according to claim 8, wherein the disc drive apparatus is a CD-ROM.
